(19) United States
(12) Patent Application Publication
(10) Pub. No.: US 2023/0395981 A1
(43) Pub. Date: Dec. 7, 2023

(54) MULTILAYER PRINTED ANTENNA ARRANGEMENTS

(71) Applicant: Argo Semiconductors SA, Hellinikon (GR)

(72) Inventor: Charalampos (Harry) CONTOPANAGOS, Kifissia (GR)

(73) Assignee: Argo Semiconductors SA, Hellinikon (GR)

(21) Appl. No.: 17/807,046

(22) Filed: Jun. 15, 2022

(30) Foreign Application Priority Data
Jun. 2, 2022 (EP) 22386034.7

(51) Int. Cl. H01Q 13/10; H01Q 1/38

(52) U.S. Cl. CPC H01Q 13/106; H01Q 1/38

(57) ABSTRACT

A monolithic antenna structure, comprising: a first metal layer; a second metal layer; a third metal layer arranged as a ground plane; a first dielectric layer between the first metal layer and the second metal layer; a second dielectric layer between the second metal layer and the third metal layer; a via feeding a signal for transmission by the antenna structure through the second dielectric layer to the second metal layer; wherein the first metal layer and the second metal layer are not electrically connected; and wherein the first metal layer acts primarily as the radiating element of the monolithic antenna structure.

### CROSS-REFERENCE TO RELATED APPLICATIONS

This application claims the benefit of European Patent Application No. 22386034.7 filed on Jun. 2, 2022, the contents of which are hereby incorporated by reference.

### TECHNICAL FIELD

This invention relates to antennas, and more particularly, to multilayer printed antenna arrangements.

### BACKGROUND

Printed microstrip antennas have great advantages in presenting small profiles and are ideal for integration into embedded architectures requiring slim form factors, either on printed circuit boards (PCBs) or, for mm-wave frequencies, on transceiver packages. They can be designed to operate in a single prescribed frequency band or in multiple prescribed frequency bands. They can further accommodate patch, dipole, or planar Inverted-F antenna (PIFA) design architectures, among others, and can be designed to possess linear polarization, dual polarization along two mutually perpendicular directions, or circular/elliptical polarization. They are readily mass-produced, are low weight, mechanically robust, and are appropriate for modern wireless communications systems.

Their small profiles, however, induce several performance limitations including: low efficiency, very narrow impedance matching frequency bandwidth which is often a fraction of a percent, poor scan performance in array applications, and poor polarization purity. Most important among those are inherently limited impedance matching bandwidths and limited radiation efficiencies due to dielectric substrate losses and, to a lesser extent, conductor losses. These losses, for directive radiation applications, result in mediocre antenna gains. In addition, for dual polarization applications, such antennas can suffer from significant cross-polarization coupling. Finally, for array applications, scanning angles for such antennas are very limited and this presents a significant disadvantage for applications in modern 5G systems where large scan angles are essential.

The prior art also contains various microstrip antennas employing multiple stacked metal layers. Some of these implementations involve proximity-coupled printed antenna patches, where the coupling is achieved through a microstrip line which is electrically coupled to the antenna through one or more coupling slots. Other implementations involve stacked antenna patches where one of the stacked patches is fed through vertical probes or vias. However, these implementations involve dielectric layers of different dielectric constants, i.e., different permittivities, most often separated by an air layer, and all such stacked patches are part of the antenna, contributing to its radiation. Other existing implementations target increase of the impedance matching bandwidth relative to the very narrow bandwidth of standard microstrip patch antennas by using a variety of parasitic metallization surrounding the antenna patch or by employing other exotic antenna shapes and architectures.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Some embodiments disclosed herein include a monolithic antenna structure, comprising: a first metal layer; a second metal layer; a third metal layer arranged as a ground plane; a first dielectric layer between the first metal layer and the second metal layer; a second dielectric layer between the second metal layer and the third metal layer; a via feeding a signal for transmission by the antenna structure through the second dielectric layer to the second metal layer; wherein the first metal layer and the second metal layer are not electrically connected; and wherein the first metal layer acts primarily as the radiating element of the monolithic antenna structure.

Some embodiments disclosed herein include a dual polarization antenna comprising a plurality of monolithic antenna structures, wherein each monolithic antenna structure, comprises a first metal layer; a second metal layer; a third metal layer arranged as a ground plane; a first dielectric layer between the first metal layer and the second metal layer; a second dielectric layer between the second metal layer and the third metal layer; a via feeding a signal for transmission by the antenna structure through the second dielectric layer to the second metal layer; wherein the first metal layer and the second metal layer are not electrically connected; and wherein the first metal layer acts primarily as the radiating element of the monolithic antenna structure; wherein the plurality of antenna structures are formed in a single printed circuit board.

### BRIEF DESCRIPTION OF THE DRAWING

In the drawing:

FIG. 1 shows an illustrative embodiment of an antenna structure arranged in accordance with the principles of the disclosure;

FIG. 2 shows a cross-sectional diagram of a version of the monolithic antenna structure of FIG. 1;

FIG. 3 shows the S-parameters of the antenna structure of FIG. 1 from its feeding ports, in dB;

FIG. 4 shows a dimetric view of the 3-D total gain radiation pattern in dBi of the antenna structure of FIG. 1, at a center frequency of 3.5 GHz, with only one of its feeding ports being supplied with a signal for transmission;

FIG. 5 shows a polar plot of the radiation gain pattern in dBi of the antenna structure of FIG. 1 on two principal planes with only a first of its feeding ports being supplied with a signal for transmission;

FIG. 6 shows a polar plot of the radiation gain pattern in dBi on two principal planes with only a second of its feeding ports being supplied with a signal for transmission;

FIG. 7 shows the S-parameters of the antenna structure of FIG. 1 from its feeding ports, in dB when the antenna structure of FIG. 1 is implemented with different set of physical parameters;

FIG. 8 shows a dimetric view of an embodiment of dual-polarization antenna array structure that employs a 2×6 array of rectangular, but not square, shaped ones of the antenna structure shown in FIG. 1;

FIG. 9 shows a top view of the antenna array structure shown in FIG. 8;

FIG. 10 shows a profile view of the total gain 3-D radiation pattern in true shape, linear scale, of the antenna array structure of FIG. 8 at a center frequency of 3.5 GHz, with the odd-numbered ports firing in-phase while the even-numbered ports are inert;

FIG. 11 shows the same pattern as is shown in FIG. 10, in dimetric view, but represented in dBi;

FIG. 12 shows the radiated gain pattern cuts in dBi on two principal planes, the X-Z and the Y-Z planes of FIG. 11, for antenna array structure of FIG. 8, with only the odd-numbered ports firing in-phase;

FIG. 13 shows a profile view of the total gain 3-D radiation pattern in true shape, linear scale, of antenna array structure of FIG. 8 at a center frequency of 3.5 GHz, with the odd-numbered ports firing according to a prescribed phase-difference in order to achieve maximum beam scanning on the Y-Z plane while the even-numbered ports are inert;

FIG. 14 shows the same pattern as is shown in FIG. 13, in dimetric view, but represented in dBi;

FIG. 15 shows the radiated gain pattern cut in dBi on the principal plane of beam scanning, which is Y-Z plane of FIG. 14;

FIG. 16 shows a dimetric view of an embodiment of dual-polarization antenna array structure that employs a 4×8 array of square-shaped ones of the antenna structure shown in FIG. 1;

FIG. 17 shows a top view of the antenna array structure of FIG. 16;

FIG. 18 shows a profile view of the total gain 3-D radiation pattern in true shape, linear scale, of the antenna array structure of FIG. 16 at a center frequency of 3.5 GHz, with the odd-numbered ports firing in-phase, while the even-numbered ports are inert;

FIG. 19 shows the same pattern as is shown in FIG. 18, in dimetric view, but represented in dBi;

FIG. 20 shows a profile view of the total gain 3-D radiation pattern in true shape, linear scale, of antenna array structure of FIG. 16 at the center frequency of 3.5 GHz, with the odd-numbered ports firing according to a prescribed phase-difference in order to achieve maximum beam scanning on the Y-Z plane, while the even-numbered ports are inert;

FIG. 21 shows the same pattern as is shown in FIG. 20, in dimetric view, but represented in dBi; and

FIG. 22 shows a dimetric view of an embodiment of a dual-polarization antenna array structure that employs a 4×8 array of rectangular antenna structures of FIG. 1.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments relate to an antenna using a 3-metal-layer architecture where the intermediate metal layer is a coupler placed very close to the radiating antenna, the whole system integrated monolithically within a single dielectric PCB, without air gaps. It is thus appropriate for inexpensive mass production, while exhibiting very high radiation efficiency on the order of 95-97%, fairly thin profiles, small areas, substantial impedance matching bandwidth reaching 8%, very high single-element gain reaching 7 dBi, and dual linear orthogonal polarization functionality. Further, a variety of dual polarization antenna array embodiments are disclosed that have compact form factors, high gains, and large scanning angles reaching ±60° from the direction perpendicular to the array surface, with side-lobes suppressed by 10 dB or more.

More specifically, the disclosed embodiments relate to a class of printed patch antennas that involve multiple metal layers all completely integrated within a single dielectric, which are of very high efficiency and significant directivity and gain. Embodiments of antennas of the types disclosed herein may have a single linear polarization, dual linear polarization, or circular polarization, and, advantageously, they may achieve substantially higher impedance matching bandwidth than traditional microstrip-fed patch antennas.

Embodiments of antennas of the types disclosed herein may be suited for synthesizing antenna arrays that are monolithically integrated into a single planar dielectric containing multiple metal layers imbedded within the dielectric thickness. Embodiments of antennas of the types disclosed herein may be fed through an intermediate dedicated metal layer that is arranged to function as a coupler and which couples the input power from feeding ports of the structure to the antenna without a direct metal contact, i.e., without being electrically connected, to the radiating patch. Embodiments of a single antenna of the type disclosed herein may provide dual linear polarization functionality and to that end may contain two radio frequency (RF) feeding ports by way of which signals for transmission may be supplied to the antenna. However, such embodiments may also be used as single polarization antenna by keeping the second feeding port inert, i.e., not supplying it with a signal for transmission, or by omitting it completely.

Embodiments of antennas as disclosed herein may be arranged into arrays such that the resulting arrays are suitable for scanning in that they have very high efficiency and large scan angles. In addition, advantageously, such arrays may be generally free of surface waves that have limited prior art microstrip arrays to small scan angles.

The operating frequency of the antenna is determined by the patch antenna size, the dielectric permittivity of the PCB, the size and shape of the coupler, the vertical distances between the coupler, the ground and the antenna and the exact coordinate, i.e., location, of each of the vertical feeding vias. These terms will be further explained hereinbelow. The impedance bandwidth depends on these parameters as well.

Illustrative embodiments disclosed herein are for an operating frequency band centered around 3.5 GHz. Those of ordinary skill in the art will readily be able to develop other embodiments suitable for use at lower or higher operating frequencies by applying the principles disclosed herein. Furthermore, additional embodiments where the dual polarization antennas can be substituted by circularly polarized antennas are possible according to the principles of the disclosure.

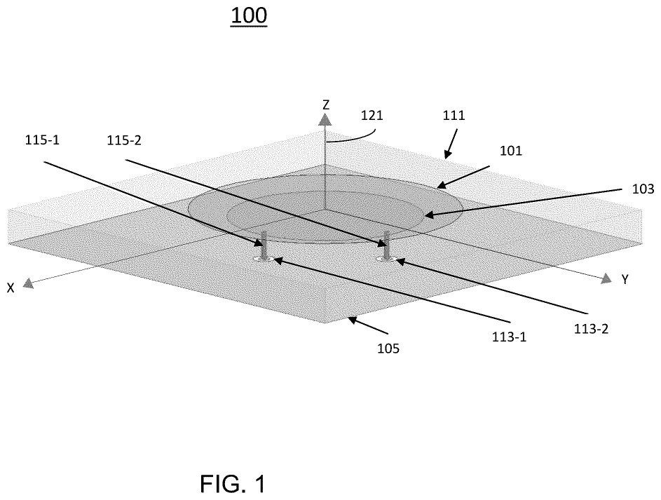

FIG. 1 shows an illustrative embodiment of antenna structure 100 arranged in accordance with the principles of the disclosure and realized monolithically, i.e., in single-dielectric printed circuit board (PCB), utilizing three metal layers, “top” metal layer M1 101, also referred to herein as antenna element 101, “intermediate” metal layer M2 103, also referred to herein as coupler element 103, and “bottom” metal layer M3 105, also referred to herein as the ground plane 105. Top and bottom as used herein are relative to each other and defined with respect to each other as shown in the orientation shown in FIG. 1. The metal employed for metal layers 101, 103, and 105 may be copper, e.g., as generally employed for wiring traces and pads in PCBs, in some embodiments.

Note that in some embodiments each of the metal layers M1 101 and M2 103 may be circular in shape. In some embodiments, metal layer M3 105 is typically, but need not be, square or oblong with respect to square, which is referred to herein generally as rectangular. The shape of metal layer M3 105 need not be the same as that of metal layer M1 101 and/or metal layer M2 103. Also, typically, metal layer M3 105 is larger than either of metal layer M1 101 and metal layer M2 103.

Generally, antenna element 101, i.e., metal layer M1 101, which is the patch antenna, and coupler element 103, i.e., metal layer M2 103, may be any polygon that has a symmetry under a 90° rotation around the central axis that goes perpendicular to and through metal layers 101, 103, and 105, i.e., the vertical Z axis shown in FIG. 1. Illustrative examples of such polygons include a square, a regular octagon, a 4-point star, an 8-point star, and so forth. Also, antenna element 101 and coupler element 103 need not have the same shape, so long as in embodiments where different shapes are employed both antenna element 101 and coupler element 103 respect the above-noted symmetry requirement. It will be appreciated by those of ordinary skill in the art that the circular shapes shown herein have the highest degree of symmetry.

Employing shapes other than circles will require fine-tuning of the design to obtain the correct resonant frequency as will be readily understood by those of ordinary skill in the art. It should also be appreciated that even when such is achieved with other shapes, impedance bandwidth and the isolation, i.e., coupling, level between the two ports producing the 2 polarizations and, consequently, the cross-polarization level in the corresponding radiation patterns, will be somewhat different from embodiments employing circular shapes. Similarly, it should be anticipated that gain levels will be somewhat different from those produced by employing circles.

Between top metal layer M1 101 and intermediate metal layer M2 103 is a dielectric layer of PCB 111 and between intermediate metal layer M2 103 and bottom metal layer M3 105 is another dielectric layer of PCB 111. In various embodiments, the dielectric layers are made of the same dielectric material but they each have a different thickness as will be explained further hereinbelow. In an embodiment, a Rogers Corporation, now owned by Dupont, RO4003C low-loss dielectric or a standard FR4 PCB containing ISOLA FR408 dielectric may be employed, where FR4 is a National Electrical Manufacturers Association (NEMA) grade designation for glass-reinforced epoxy laminate material and where “FR” stands for “Flame Retardant. The number “4” indicates a type 4 woven-glass-reinforced epoxy resin.

In various embodiments PCB 111 may have a rectangular shape, which may be square, as specifically show in FIG. 1, or it may be oblong with respect to square, which, again, as noted above, is referred to herein generally as rectangular. Alternatively, PCB 111 may have a shape selected at the discretion of the implementer.

In various embodiments, as suggested above, top metal layer M1 101 is employed as a patch antenna element and is fabricated on top of PCB 111. Intermediate metal layer M2 103 operates as a coupler that couples signal for transmission from at least one of a radio frequency (RF) feeding ports 113 of the antenna structure to antenna element 101 without conductive direct contact, i.e., an electrical connection, to antenna element 101, and hence may be referred to herein as a coupler. Bottom metal layer M3 105 is the ground, i.e., the ground plane, of the antenna. As noted, intermediate metal layer M2 103 is conductively connected to at least one of feeding ports 113-1 and 113-2, which may be referred to herein collectively as feeding ports 113 of antenna structure 101, by a respective one of vertical vias 115-1 and 115-2, which may be referred to collectively herein as vias 115. At least one of feeding ports 113 is fed the signal to be transmitted by antenna structure 101, e.g., from respective coaxial cables, not shown, in the conventional manner. Each signal is then transported from its one of feeding ports 113 by a respective one of vias 115 to the coupler, i.e., intermediate layer M2 103. Thus, intermediate layer M2 103 is fed the signal to be transmitted from feeding ports 113.

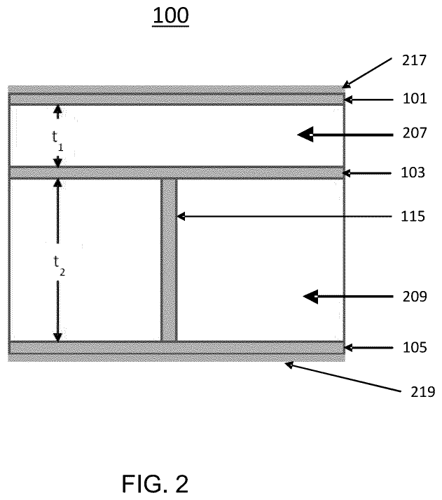

FIG. 2 shows a cross-sectional diagram of a version of monolithic antenna structure 100 of FIG. 1. Again, seen in FIG. 2 are top metal layer M1 101, intermediate metal layer M2 103, and bottom metal layer M3 105. Also, now visible in FIG. 2 are dielectric layers 207 and 209, which are the dielectric of which PCB 111 is made and which, as indicated hereinabove, in all embodiments are made of the same dielectric material. However, in the embodiment shown in FIG. 2, dielectric layers 207 and 209 have different thicknesses.

Also visible in FIG. 2 is one of vias 115. Those of ordinary skill in the art will appreciate that, unlike in FIG. 1, due to the nature of the cross section the gap in metal layer M3 through which via 115 passes cannot be seen in FIG. 2.

Also shown in FIG. 2, which was not shown in FIG. 1 for clarity of exposition, are optional coatings 217 and 219, also known as solder masks. Coating 217 lies above top metal layer 101 and coating 219 lies below bottom metal layer M3 105. Coatings 217 and 219 are conventionally employed extra-thin coatings that are used to cover exposed metals in order to protect them from surface corrosion. In some embodiments where optional coatings 217 and 219 are not employed, the exterior facing metal surfaces of metal layers M1 101 and M3 105 may be appropriately treated to avoid the need for coatings 217 and 219. Coatings 217 and 219 are shown for completeness because they are typically employed in practical circuit boards and they are particularly used in several embodiments described hereinbelow.

The operating frequency of the antenna is determined by the patch antenna size, the dielectric permittivity of the PCB, the size and shape of the coupler, the vertical distances between the coupler, the ground and the antenna and the exact coordinate of the vertical feeding via. The impedance bandwidth depends on these parameters as well, as further set forth hereinbelow.

In one embodiment, antenna structure 100 employs a Rogers low-loss dielectric material, the overall system area, i.e., the size of PCB 111, is 40×40 mm², and the system thickness is 4.2 mm-4.4 mm. In terms of free-space wavelength λ at a center frequency (f_{c}) of 3.5 GHz, the system area in terms of the wavelength of center frequency f_{c} may be expressed as 0.467×0.467λ², which is the electrical quantification of the size of the area, and the thickness, i.e., the electrical thickness of PCB 111 of antenna structure 100 is 0.05λ. The electrical thickness of an embodiment of antenna structure 100 is defined, as is well known, as the actual physical geometrical thickness of antenna structure 100 as a percentage of the operating wavelength of antenna structure 100 at the resonant frequency. Note that this electrical thickness quantifies how “thick” antenna structure 100 is electrically. More specifically, it is a statement characterizing how thick the design is electrically, after the design is optimized, in order to highlight consistently the electrical thickness of designs that perform well.

If an antenna of a single-polarization is desired, then only one of feeding ports 113 and its respective one of vias 115 may be employed. In embodiments for use as a dual-polarization antenna both of feeding ports 113 and the corresponding, respective ones of vias 115 are employed, which are rotated by 90° with respect to each other around the common center of antenna element 101, coupler element 103, and ground plane 105, in the manner shown in FIG. 1. For brevity, FIG. 1 presents both possibilities as described herein, with feeding port 113-1 on the x-axis and feeding port 113-2 on the y-axis.

Although the illustrative embodiments shown and described herein employ a circular shape for antenna element 101 and coupler element 103 other polygonal shapes may be employed as well, as will be readily understood by those of ordinary skill in the art. Furthermore, antenna element 101 and coupler element 103 need not have the same shape.

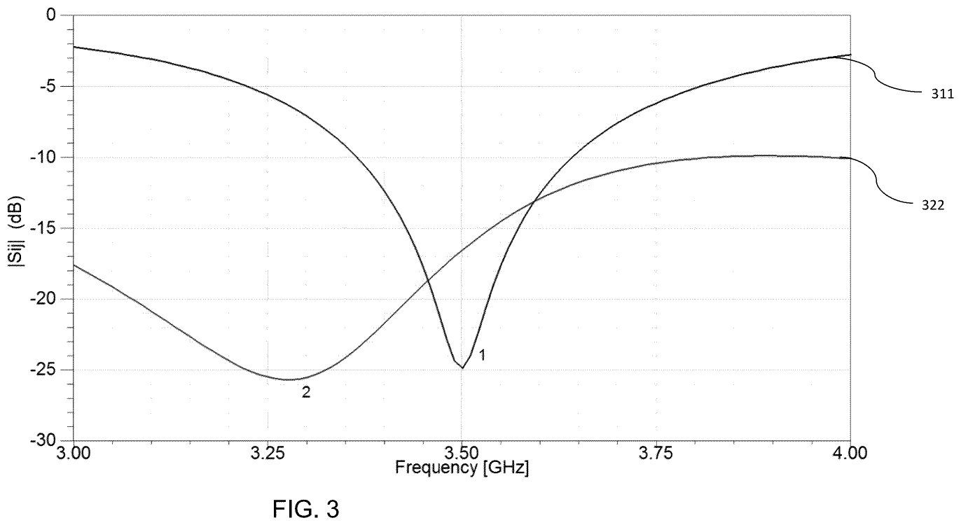

FIG. 3 shows the return loss, i.e., reflected power, 311 |S₁₁| and |S₂₂| of the antenna structure 100 from feeding ports 113-1 and 113-2, in decibels (dB). The system resonates at a center frequency f_{c}=3.5 GHz. The impedance matching to a 50-Ohm RF port is excellent at −25 db. The impedance matching bandwidth at the −10 dB level is 280 MHz, or 8% with respect to its center frequency. This defines the operating frequency band of the device. FIG. 3 also shows the isolation, i.e., coupling, |S₂₁| 322 between feeding ports 113-1 and 113-2. There is minimal coupling of −17 dB between feeding ports 113-1 and 113-2 at the center frequency, indicating that to a very high degree the two linear polarizations work independently of each other. This shows that the embodiment of FIG. 1 has a very high polarization purity.

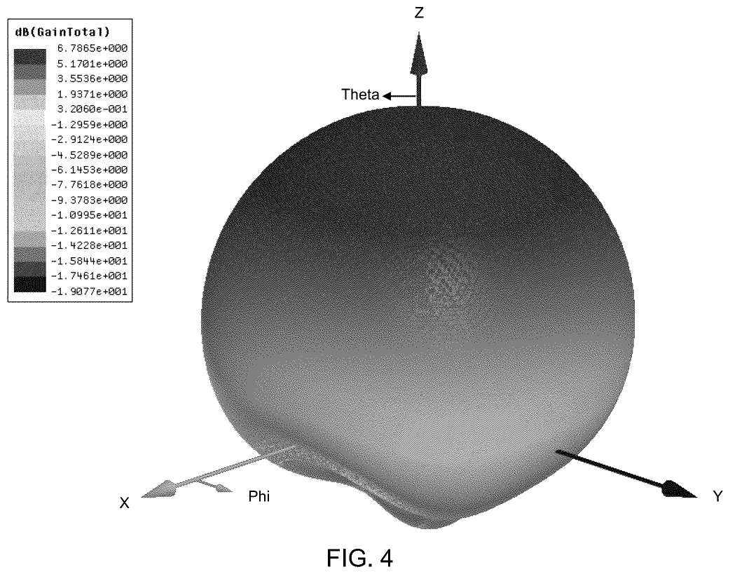

FIG. 4 shows a dimetric view of the 3-D total gain radiation pattern in dBi of the antenna structure 100 of FIG. 1, at a center frequency of 3.5 GHz, with only feeding port 113-1 being supplied with a signal for transmission, i.e., only feeding port 113-1 is being fired, and no signal being supplied to feeding port 113-2, i.e., feeding port 113-2 is inert. This view shows that antenna structure 100 is a very directive antenna, having a single radiation beam upwards, i.e., broadside. The maximum gain is 6.8 dBi, which is quite high for a printed element having these dimensions.

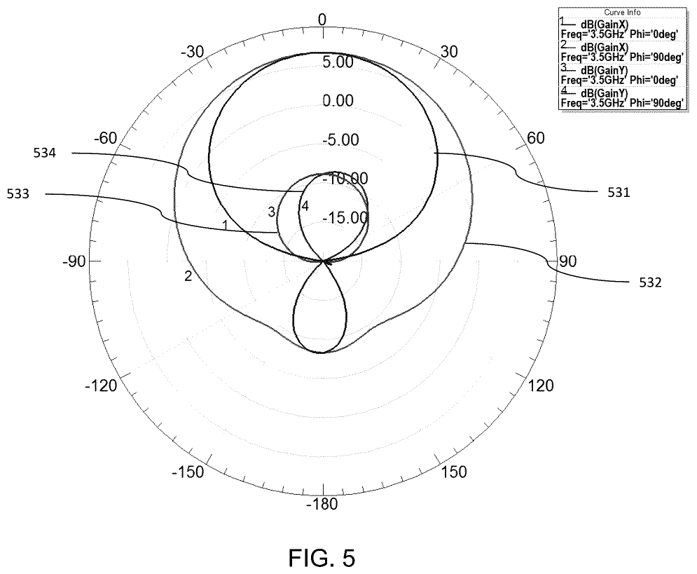

FIG. 5 shows a polar plot of the radiation gain pattern in dBi of the antenna structure 100 of FIG. 1 on two principal planes with only feeding port 113-1 being supplied with a signal for transmission and no signal being supplied to feeding port 113-2. More specifically, FIG. 5 shows the radiated gain pattern cuts in dBi on two principal planes, the X-Z and the Y-Z planes of FIG. 1, with only feeding port 113-1 being supplied with a signal for transmission and no signal being supplied to feeding port 113-2. The gain obtained from the electric field component directed along the x-axis is G_{X} (θ, φ=0°) for the X-Z cut, and G_{X} (θ, φ=90°) for the Y-Z cut, while the gain obtained from the electric field component directed along the y-axis is G_{Y} (θ, φ=0°) for the X-Z cut, and G_{Y} (θ, φ=90°) for the Y-Z cut. The electromagnetic radiation emitted from this embodiment of the antenna is very highly linearly polarized, with curve 531, being for G_{X} (θ, φ=0°), and curve 532, being for G_{X} (θ, φ=90°), showing the gain obtained from the electric field component directed along the x-axis accounting for the total gain of the system. The cross-polarization level indicated by curve 533, being for G_{Y} (θ, φ=0°), and curve 534 being for G_{Y} (θ, φ=90°) showing that the gain due to the electric field component directed along the y-axis is suppressed by about 16 dB, relative to the co-polarized radiation. Despite the very small size of the system, e.g., less than λ/2, the back-radiation is quite suppressed, with the front-to-back gain ratio being about 15 dB.

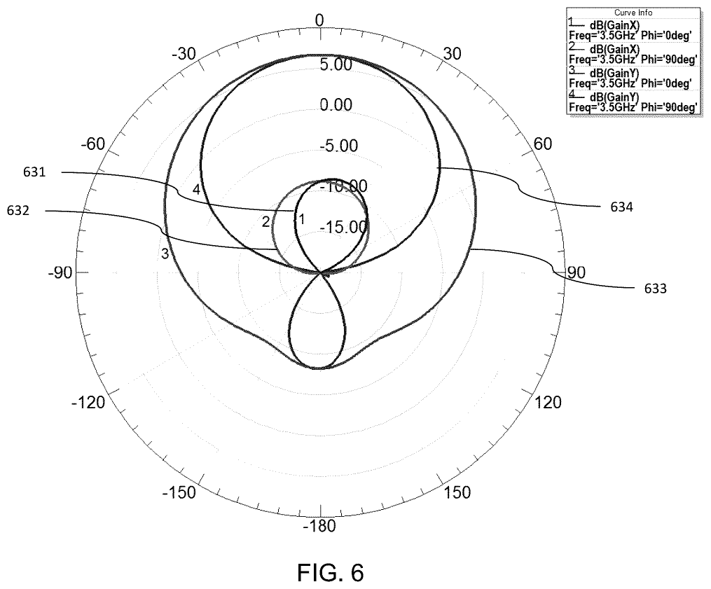

FIG. 6 shows a polar plot of the radiation gain pattern in dBi on two principal planes with only feeding port 113-2 being supplied with a signal for transmission and no signal being supplied to feeding port 113-1. More specifically, FIG. 6 shows the radiated gain pattern cuts in dBi on two principal planes, the X-Z and the Y-Z planes of FIG. 1, with only feeding port 113-2 being supplied with a signal for transmission and no signal being supplied to feeding port 113-1.

The gain obtained from the electric field component directed along the x-axis are G_{X} (θ, φ=0°) for the X-Z cut and G_{X} (θ, φ=90°) for the Y-Z cut. These are very much suppressed. On the other hand, the gain obtained from the electric field component directed along the y-axis which is G_{Y} (θ, φ=0°) for the X-Z cut and G_{Y} (θ, φ=90°) for the Y-Z cut, are the ones accounting for the total gain. The electromagnetic radiation emitted from antenna structure 100 is also very highly linearly polarized, with curves 633 and 634 of FIG. 6 showing the gain obtained from the electric field component directed along the y-axis accounting for the total gain of the system, while the cross-polarization level, curves 631 and 632 of FIG. 6, showing that the gain due to the electric field component directed along the x-axis is suppressed by about 16 dB, relative to the co-polarized radiation.

The direction of polarization is the line connecting the coordinates of the connection point of one of vias 115 being supplied with a signal to transmit to the coupler with the center of coupler element 103, which is also the common center of antenna element 101, coupler element 103, and ground plane 105.

For pedagogical purposes, the two independent polarizations have been chosen to be along the sides of PCB 111 of antenna structure 100, i.e., along the directions X and Y of FIG. 1. As will be appreciated by those of ordinary skill in the art, the two independent polarizations may be aligned along two different mutually orthogonal directions that are rotated by an angle φ₀ relative to PCB 111 by rotating the antenna element 101, coupler element 103, feeding ports 113 and vertical vias 115 of antenna structure 100 by an angle φ₀ with respect to the fixed coordinate system of FIG. 1.

The size of antenna structure 100 and the dielectric constant of the dielectric layers of PCB 111, i.e., dielectric layers 207 and 209, are the primary determinants of the operating frequency band of the antenna, as is well-known and expected for printed antennas.

The size of coupler element 103 also contributes to the center frequency of operation. Finally, the exact positioning of each of vias 115, the distances t₁ between ground plane 105 and coupler element 103 and t₂ between coupler element 103 and antenna element 101, respectively, also affect the center frequency, as well as the impedance matching bandwidth and maximum gain of the antenna structure 100. Note the total of t₁ and t₂ corresponds to the thickness of the substrate. Various values for these design parameters are disclosed herein for various embodiments.

For brevity of description, the following notation shall be employed:
D₁=diameter of antenna element 101
D₂=diameter of coupler element 103
t₁=vertical distance between adjacent surfaces of metal layer M1 101 and metal layer M2 103
t₂=vertical distance between adjacent surfaces of metal layer M2 103 and metal layer M3 105
R_{V1}=distance between the center of coupler element 103 and the center of via 115-1
R_{V2}=distance between the center of coupler element 103 and the center of via 115-2
t_{Mi}=thickness of metal layer Mᵢ, i=1, 2, and 3, corresponding to metal layers 101, 103, and 105, respectively

In one embodiment, antenna structure 100 employing the parameters of: D₁=24.85 mm, D₂=17.61 mm, t₁=0.79 mm, t₂=3.4 mm, R_{V1}=R_{V2}=7.75 mm achieves the performance shown in FIGS. 2-6. The thickness of all metal layers 101, 103, and 105 has been chosen to be the same and it has been observed that using metal layer thickness in the range from about 15 μm to about 70 μm results in no significance difference in performance. Hence the total thickness of the antenna structure, including the thickness of metal layers 101, 103, and 105, ranges from 4.2 mm for the 15 μm-thick metal layers up to 4.4 mm for the 70 μm-thick metal layers. In this embodiment, PCB 111 on which antenna structure 100 is formed is a square cell of 40×40 mm². The thickness, i.e., its electrical thickness, at a center frequency of 3.5 GHz, is 0.05λ.

If a solder mask is used to coat metal layer M1 101, as shown in FIG. 2, all the design parameters remain the same as above, except that the antenna diameter needs to be slightly smaller, D₁=24.75 mm, in order for the design to operate at the same center frequency of 3.5 GHz, since the protective solder mask dielectrically loads antenna structure 101. Whether or not a solder mask is used to cover metal layer M3 105 makes no difference to the design parameters. One may want to cover metal layer M3 105 with a solder mask to provide corrosion protection.

Another embodiment of antenna structure 100 employs D₁=24.88 mm, D₂=13.21 mm, t₁=0.79 mm, t₂=3.4 mm, R_{V1}=R_{V2}=5.81 mm and the thickness of metal layers 101, 103, and 105 can vary as described hereinabove. In this embodiment, antenna structure 100 again occupies a square cell of 40×40 mm² on PCB 111. Such an embodiment can provide an even higher polarization purity than is shown in FIGS. 5 and 6. Such an embodiment keeps the area of the system the same as in FIG. 1 and targets the same gain as shown in FIG. 4. The trade-off is a decrease in the impedance matching bandwidth of FIG. 3 in exchange for a physically thinner overall system and an even higher polarization purity than the 16 dB suppression shown in FIGS. 5 and 6. This thinner system has a total thickness of 3.1 mm-3.3 mm or about 0.037λ. Its cross-polarization suppression is about 20 dB, leading to a polarization purity enhancement by about 4 dB relative to the embodiment employing the parameters of: D₁=24.85 mm, D₂=17.61 mm, t₁=0.79 mm, t₂=3.4 mm, R_{V1}=R_{V2}=7.75 mm.

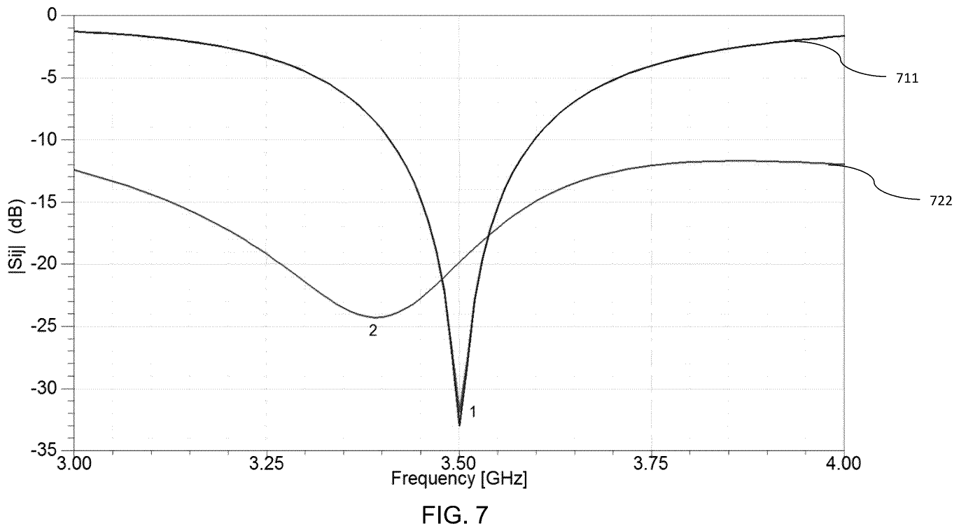

FIG. 7 shows the return loss, i.e., reflected power, |S₁₁| and |S₂₂| of the antenna structure 101 from feeding ports 113-1 and 113-2, in decibels (dB) of antenna structure 100 when it is implemented using the immediately preceding parameters. The two curves, i.e., the curves for each of feeding ports 113, are identical and denoted by 711 in FIG. 7. Antenna structure 100 resonates at the same center frequency f_{c}=3.5 GHz. The impedance matching to a 50-Ohm radio frequency (RF) port, is excellent at −33 dB. The impedance matching bandwidth at the −10 dB level is 190 MHz, or 5.5% with respect to the center frequency. FIG. 7 also shows the isolation, i.e., coupling, |S₂₁| 722 between feeding ports 113-1 and 113-2. Using these parameters to implement antenna structure 100 causes the coupling to be significantly smaller than the already small coupling of the embodiment of antenna structure 100 using the parameters described first hereinabove and is equal to −20 dB between feeding ports 113-1 and 113-2 at the center frequency, i.e., it is reduced to half its previous value.

Yet another embodiment of antenna structure 100, in which a solder mask is used to coat metal layer M1 101, may be implemented using D₁=24.75 mm, D₂=17.61 mm, t₁=0.79 mm, t₂=3.4 mm, R_{V1}=R_{V2}=7.75 mm, and the thickness of metal layers 101, 103, and 105 of each of antenna structures 100 are all the same but the particular thickness in any particular implementation can be varied as described above. In this embodiment, PCB 111 on which antenna structure 100 is formed in this embodiment is a rectangular cell with dimensions of 45×55 mm². The electrical thickness of this embodiment at a center frequency of 3.5 GHz is 0.05λ.

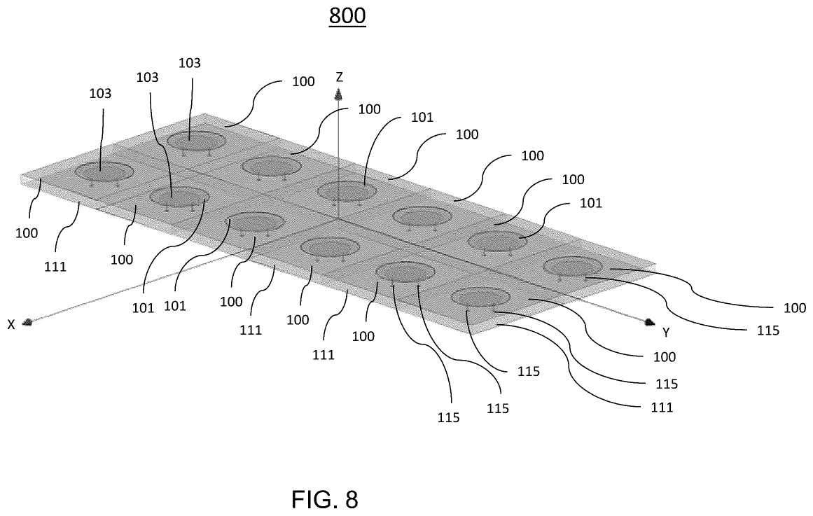

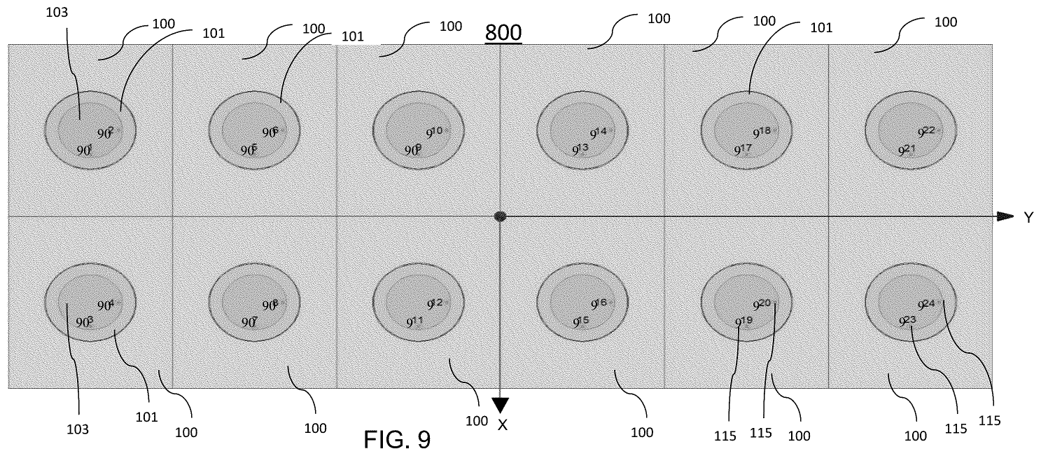

FIG. 8 shows a dimetric view of an embodiment of dual-polarization antenna array structure 800 that employs a 2×6 array of rectangular shaped antenna structures 100, i.e., the antenna structures 100 are arranged as in 2 rows of 6 antenna structures 100. In one implementation of the embodiment of antenna array structure 800, each of antenna structures 100 is implemented as employing D₁=24.75 mm, D₂=17.61 mm, t₁=0.79 mm, t₂=3.4 mm, R_{V1}=R_{V2}=7.75 mm, a solder mask being used to coat metal layer M1 101, to form a 2×6 antenna array in a single monolithic PCB and each having, if they were individual units, a PCB with a rectangular shape having dimensions of 45×55 mm². The thickness of all metal layers 101, 103, and 105 may be the same and within the range from about 15 μm to about 70 μm as it has been determined that using different values in the range results in no significance difference in performance. Each individual antenna structure 100 of the array may be referred to as a cell and there are 12 cells that make up antenna array structure 800. FIG. 9 shows a top view of antenna array structure 800.

Antenna array structure 800 is constructed by unifying on a single substrate the metal layers of the corresponding antenna structures 100. In particular, the ground layer, i.e., metal layer M3 105, of each of antenna structures 100 is joined along their individual borders to obtain a single continuous metal layer M3 which serves as a unified ground for the whole array. Similarly, the respective dielectric substrate layers 207 and 209 of each of the individual antenna structures 100 are each unified into a respective continuous substrate layer. The contours of the individual antenna structures 100 that make up antenna array structure 800 are shown simply to illustrate how the array is composed from the individual antenna structures 100. These contours do not exist in the actual design or fabrication. The total size of the array is 11×27 cm². Note that to avoid over cluttering FIGS. 8 and 9, reference numerals are provided for only some of antenna structures 100 and their individual features.

The 12 antenna structures 100 of the antenna array structure 800 can be excited, e.g., by simultaneously feeding odd numbered ones of feeding ports 113, i.e., ports 901, 903, 905, 907, 909, 911, 913, 915, 917, 919, 921, and 923, shown in FIG. 9, which is a top view of antenna array structure 800, to create polarizations that are parallel to the x-axis while the remaining even numbered ones of feeding ports 113, i.e., ports 902, 904, 906, 908, 910, 912, 914, 916, 918, 920, 922, and 924 are inert. Alternatively, ports 902, 904, 906, 908, 910, 912, 914, 916, 918, 920, 922, and 924 may be simultaneously fed to create polarizations parallel to the y-axis while the remaining odd numbered ports, i.e., ports 901, 903, 905, 907, 909, 911, 913, 915, 917, 919, 921, and 923 are inert. Alternatively, any combination of the 24 ports shown may be fed.

The resulting radiation patterns exhibit a variety of beamforming characteristics some of which are described hereinbelow and which present certain beamforming characteristics related to the scanning performance of the array that are of interest to 5G scanning applications.

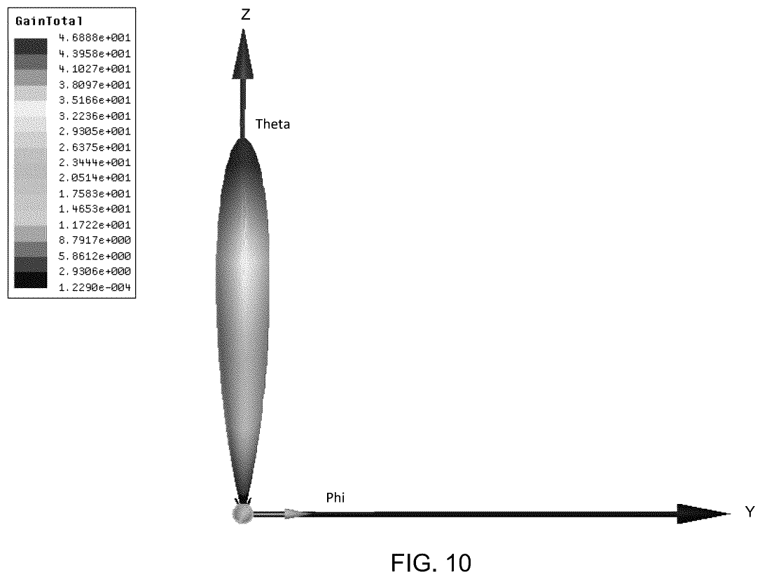

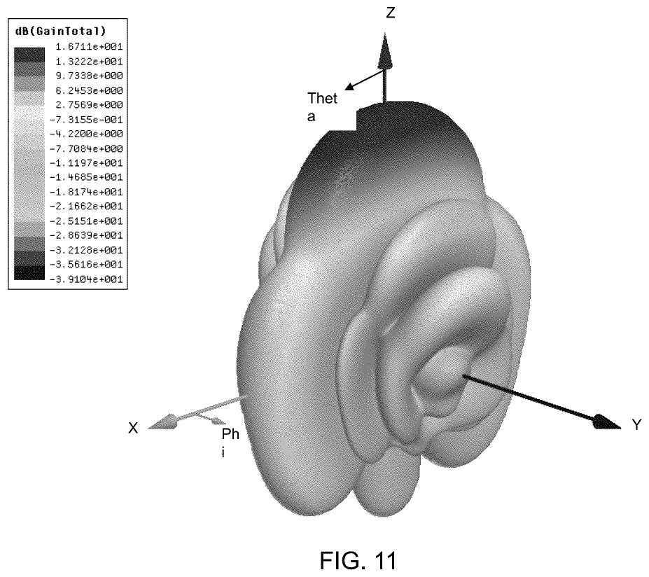

FIG. 10 shows a three-dimensional profile of the total gain 3-D radiation pattern in true shape, linear scale, of the antenna array structure 800 at a center frequency of 3.5 GHz, with the odd-numbered ports firing, i.e., being supplied with a signal for transmission, in-phase while the even-numbered ports are inert. FIG. 11 shows a dimetric view of the same pattern in dBi. As can be seen, the array is very directional, having a single radiation beam upwards, i.e., broadside. The maximum gain is 16.7 dBi, which is quite high for a printed element of these dimensions, while the radiation efficiency of the array is 97%. The single directive electromagnetic beam of energy is directed broadside, while radiation behind the device is very small, being suppressed by more than 18 dB.

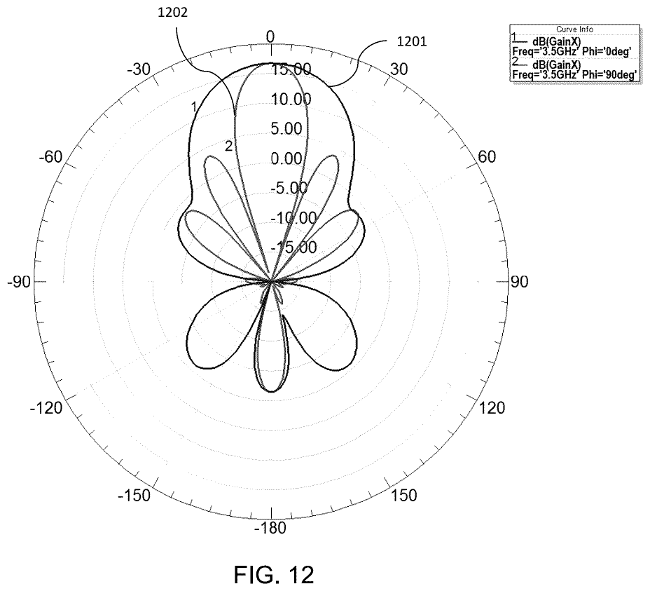

FIG. 12 shows the radiated gain pattern cuts in dBi on two principal planes, the X-Z and the Y-Z planes of FIG. 11 for antenna array structure 800, with only the odd-numbered ports firing in-phase. Only the gains obtained from the electric field component directed along the x-axis are shown, i.e., G_{X} (θ, φ=0°) for the X-Z cut, and G_{X} (θ, φ=90°) for the Y-Z cut. The electromagnetic radiation emitted is very highly linearly polarized, with the curves 1201 and 1202 of the plot showing the gain obtained from the electric field component directed along the x-axis accounting for the total gain of the system, indicating a negligible cross-polarization level.

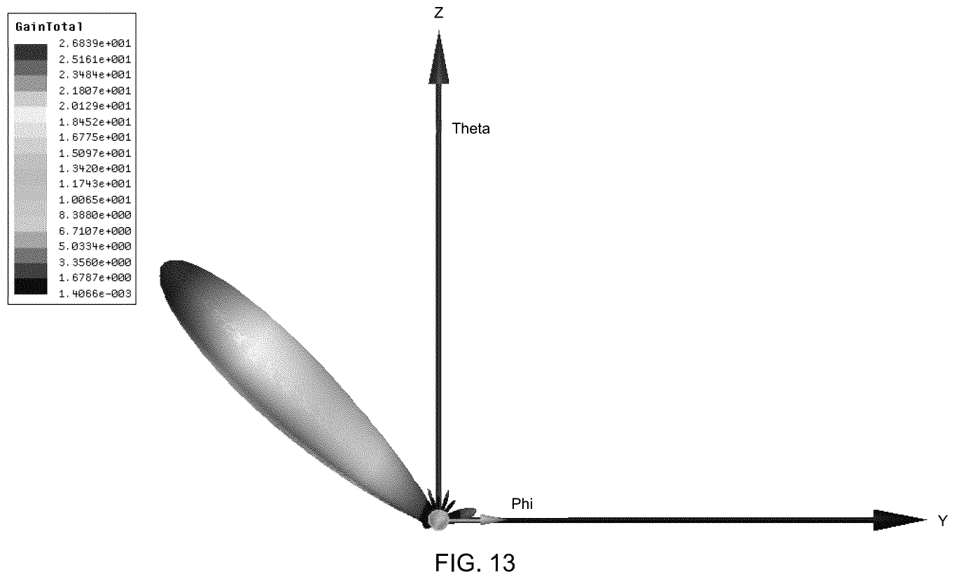

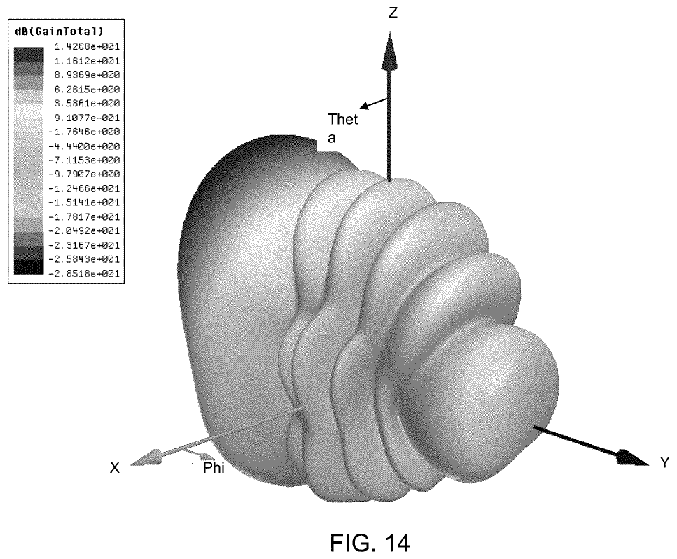

FIG. 13 shows a profile view of the total gain 3-D radiation pattern in true shape, linear scale, of antenna array structure 800 at the center frequency of 3.5 GHz, with the odd-numbered ports firing, i.e., being supplied with a signal for transmission, according to a prescribed phase-difference in order to achieve maximum beam scanning on the Y-Z plane while the even-numbered ports are inert. FIG. 14 shows a dimetric view of the same pattern in dBi. Radiation efficiency is 95%.

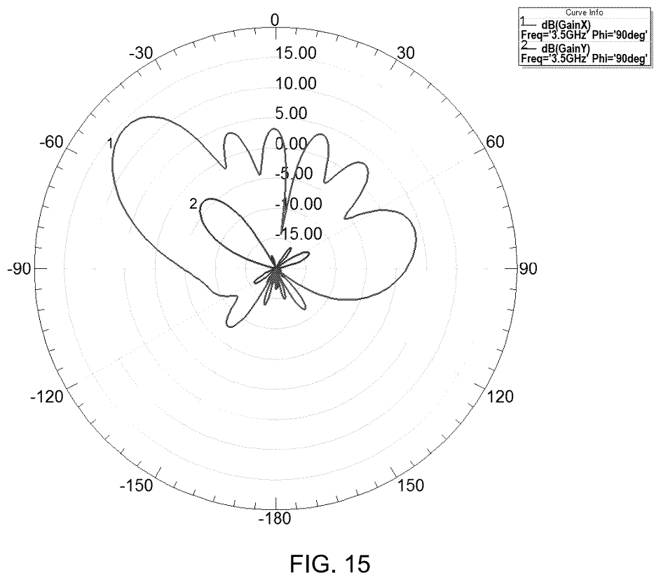

FIG. 15 shows a polar plot of the radiation gain pattern in dBi on the principal plane of beam scanning under these conditions, which is Y-Z plane of FIG. 14 when the odd-numbered ports are excited according to a prescribed phase-difference in order to achieve maximum beam scanning on the Y-Z plane while the even-numbered ports are inert. The gain obtained from the electric field component directed along the x-axis G_{X} (θ, φ=90°) is plotted for the Y-Z cut, and the gain obtained from the electric field component directed along the y-axis G_{Y} (θ, φ=90°), i.e., cross-polarization, for the Y-Z cut. The beam is scanned to an angle of 50°, with a total gain of 14.3 dBi, only 2.5 dB lower than the in-phase broadside gain of FIG. 11. Hence, antenna array structure 800 achieves angular scanning of ±50° with a 2.5 dB gain drop. The side-lobe level is suppressed by at least 10 dB relative to the main beam. The cross-polarization level is suppressed by at least 18 dB relative to the main beam, indicating excellent polarization purity for this embodiment of the array. The radiation efficiency of the array for this condition, as noted, is 95%.

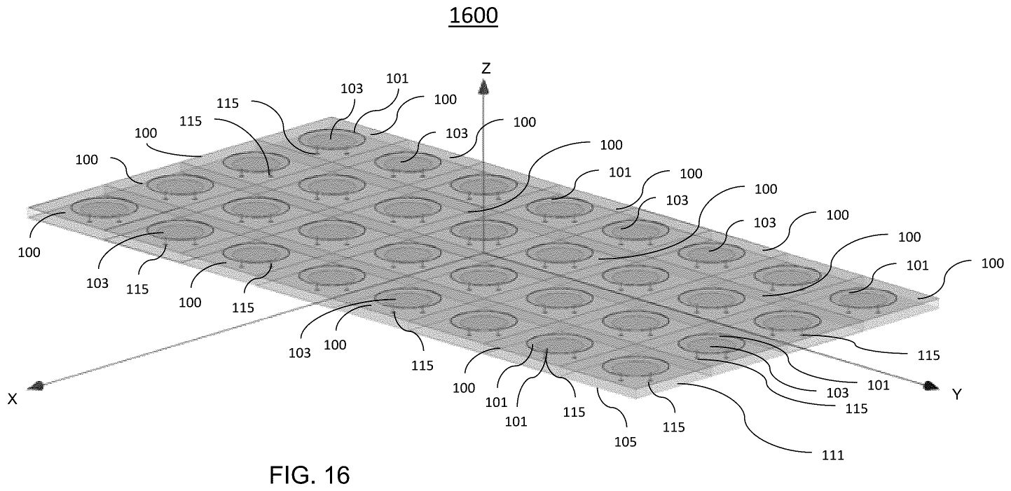

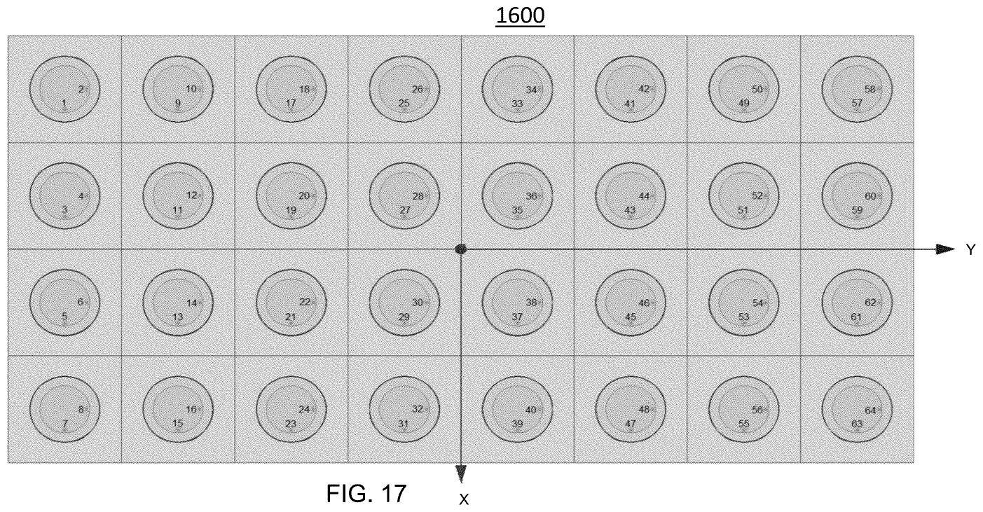

FIG. 16 shows a dimetric view of an embodiment of dual-polarization antenna array structure 1600 that employs a 4×8 array of square-shaped antenna structures 100, i.e., the antenna structures 100 are arranged as in 4 rows of 8 elements, for a total of 32 antenna structures 100. In one implementation of the embodiment of antenna array structure 1600, each of antenna structures 100 is implemented as employing antenna structure 100 employing the parameters of: D₁=24.85 mm, D₂=17.61 mm, t₁=0.79 mm, t₂=3.4 mm, R_{V1}=R_{V2}=7.75 mm to form a 4×8 antenna array in a single monolithic PCB and each having, if they were individual units, a square shape of PCB 111 of 40×40 mm². The thickness of all metal layers 101, 103, and 105 of each of antenna structures 100 may be the same and within the range from about 15 μm to about 70 μm as it has been determined that using different values in the range results in no significance difference in performance. Each individual antenna structure 100 of the array may be referred to as a cell and there are 32 cells that make up antenna array structure 1600. FIG. 17 shows a top view of antenna array structure 1600.

Antenna array structure 1600 is constructed by unifying on a single substrate the metal layers of the corresponding antenna structures 100. In particular, the ground layer, i.e., metal layer M3 105, of each of antenna structures 100 is joined along their individual borders to obtain a single continuous metal layer M3 which serves as a unified ground for the whole array. Similarly, the respective dielectric substrate layers 207 and 209, not distinctly visible in FIG. 16, of each of the individual antenna structures 100 are each unified into a respective continuous substrate layer. The contours of the individual antenna structures 100 that make up antenna array structure 1600 are shown simply to illustrate how the array is composed from the individual antenna structures 100. These contours do not exist in the actual design or fabrication. The total size of the array is 16×32 cm². Note that to avoid over cluttering FIGS. 16 and 17, reference numerals are provided for only some of antenna structures 100 and their individual features.

The 32 antenna structures 100 of the antenna array structure 1600 can be excited, e.g., by simultaneously feeding, i.e., supplying signal for transmission to, odd numbered ones of feeding ports 113, i.e., ports 1, 3, 5, 7, 9, 11, 13, 15, 17, 19, 21, and 23, shown in FIG. 17, which is a top view of antenna array structure 1600 to create polarizations that are parallel to the x-axis while the remaining even numbered ones of feeding ports 113, i.e., ports 2, 4, 6, 8, 10, 12, 14, 16, 18, 20, 22, and 24 are inert. Alternatively, ports 2, 4, 6, 8, 10, 12, 14, 16, 18, 20, 22, and 24 may be simultaneously fed to create polarizations parallel to the y-axis while the remaining odd numbered ports, i.e., ports 1, 3, 5, 7, 9, 11, 13, 15, 17, 19, 21, and 23 are inert. Alternatively, any combination of the 32 ports shown may be fed.

The resulting radiation patterns exhibit a variety of beamforming characteristics some of which are described hereinbelow and which present certain beamforming characteristics related to the scanning performance of the array that are of interest to 5G scanning applications.

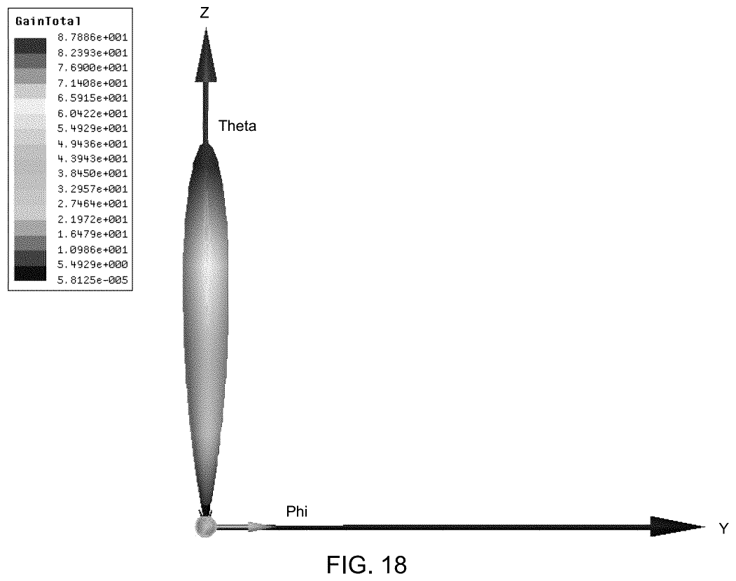

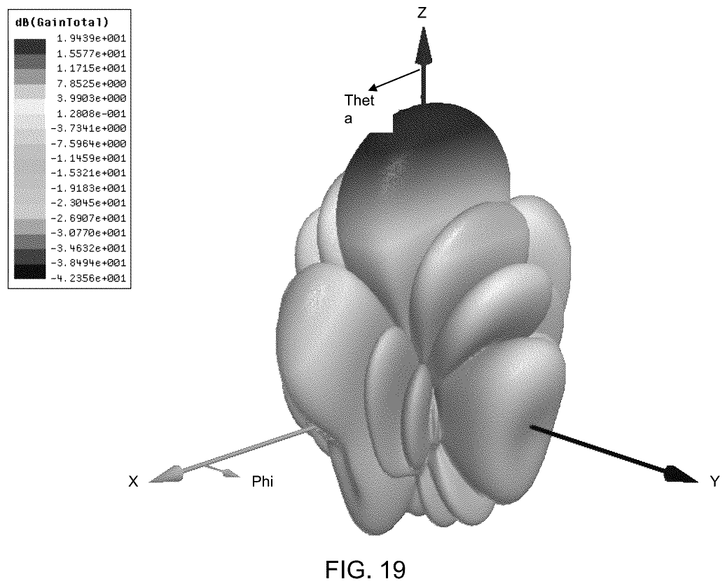

FIG. 18 shows a three-dimensional profile of the total gain 3-D radiation gain pattern in true shape, linear scale, of the antenna array structure 1600 at a center frequency of 3.5 GHz, with the odd-numbered ports firing in-phase, while the even-numbered ports are inert. FIG. 19 shows, a dimetric view of the same pattern in dBi. As can be seen, the array is very directional, having a single radiation beam upwards, i.e., broadside. The maximum gain is 19.4 dBi, which is quite high for a printed element of these dimensions, while the radiation efficiency of the array is 98%. The single directive electromagnetic beam of energy is directed broadside, while radiation behind the device is negligible, being suppressed by 35 dB.

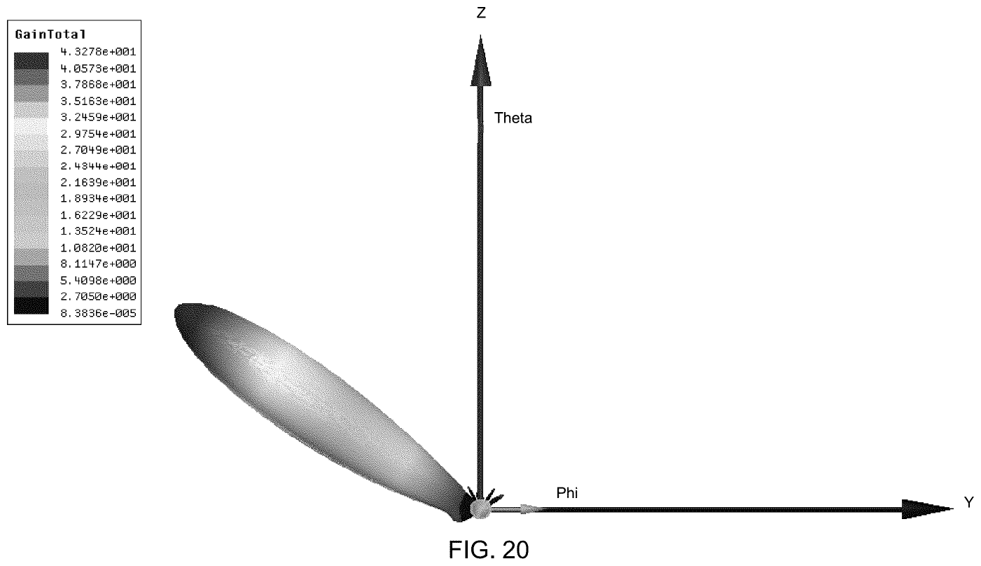

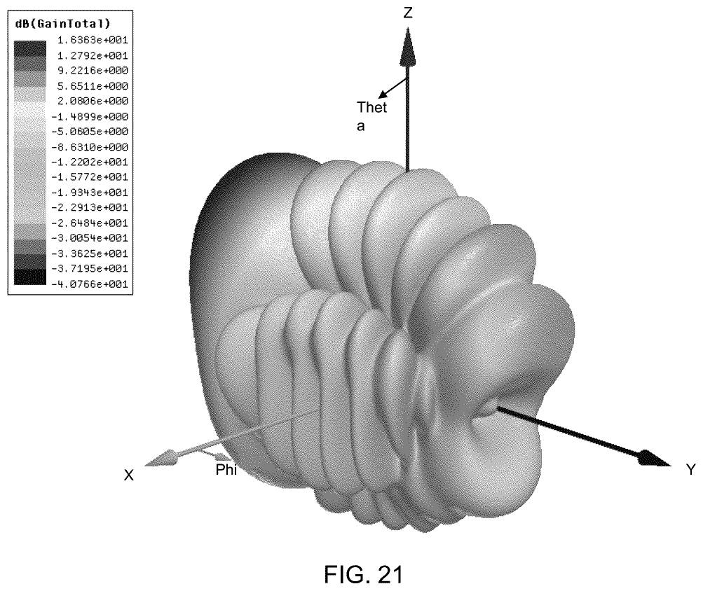

FIG. 20 shows a profile view of the total gain 3-D radiation pattern in true shape, linear scale, of antenna array structure 1600 at the center frequency of 3.5 GHz, with the odd-numbered ports firing according to a prescribed phase-difference in order to achieve maximum beam scanning on the Y-Z plane, while the even-numbered ports are inert. FIG. 21 shows a dimetric view of the same pattern in dBi. Radiation efficiency is 92%.

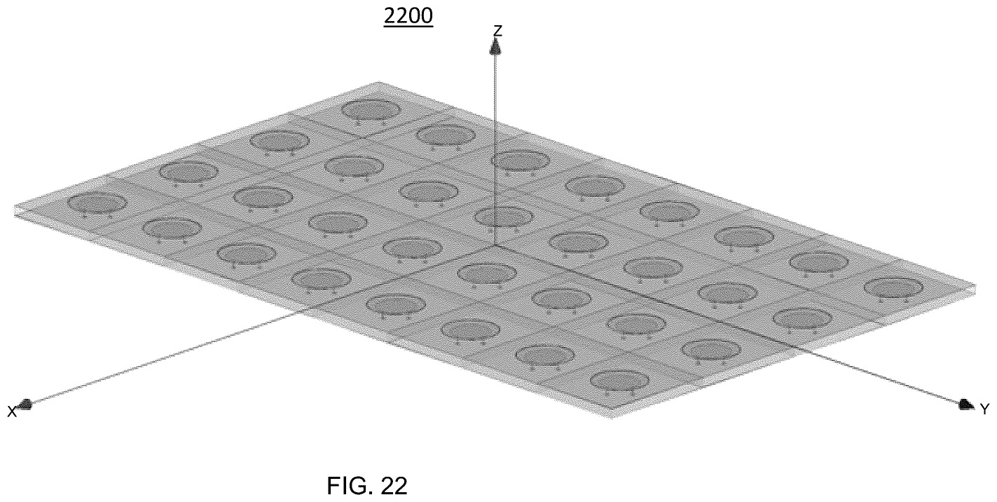

FIG. 22 shows a dimetric view of an embodiment of dual-polarization antenna array structure 2200 that employs a 4×8 array of antenna structures 100, i.e., the antenna structures 100 are arranged as in 4 rows of 8 elements, for a total of 32 antenna structures 100, thus the arrangement is similar to that of antenna array structure 1600. In one implementation of the embodiment of antenna array structure 2200, each of antenna structures 100 is implemented as employing antenna structure 100 employing the parameters of: D₁=24.75 mm, D₂=17.61 mm, t₁=0.79 mm, t₂=3.4 mm, R_{V1}=R_{V2}=7.75 mm to form a 4×8 antenna array in a single monolithic PCB and each having, if they were individual units, a rectangular shape of PCB 111 having dimensions of 45×55 mm². The thickness of all metal layers 101, 103, and 105 of each of antenna structures 100 may be the same and within the range from about 15 μm to about 70 μm as it has been determined that using different values in the range results in no significance difference in performance. Each individual antenna structure 100 of the array may be referred to as a cell and there are 32 cells that make up antenna array structure 2200.

Antenna array structure 2200 is constructed by unifying on a single substrate the metal layers of the corresponding antenna structures 100. In particular, the ground layer, i.e., metal layer M3 105, of each of antenna structures 100 is joined along their individual borders to obtain a single continuous metal layer M3 which serves as a unified ground for the whole array. Similarly, the respective dielectric substrate layers 207 and 209, not distinctly visible in FIG. 22, of each of the individual antenna structures 100 are each unified into a respective continuous substrate layer. The contours of the individual antenna structures 100 that make up antenna array structure 22 are shown simply to illustrate how the array is composed from the individual antenna structures 100. These contours do not exist in the actual design or fabrication. The total size of the array is 22×36 cm².

The same numbering of feeding ports 113 employed in FIG. 16 may be used with regard to FIG. 22.

Given the foregoing, those of ordinary skill in the art will be readily able to develop other embodiments based on the principles of the disclosure but some guidance in this regard is provided hereinbelow.

For example, in some embodiments, instead of using Rogers RO4003C as the dielectric a standard FR4 PCB, e.g., one using ISOLA FR408 dielectric, may be employed. Such will result in a less expensive antenna. In one such embodiment, the overall system area, i.e., the size of PCB 111, is 40×40 mm², and the system thickness is 4.2 mm-4.4 mm. Values of D₁=24.5 mm, D₂=17.61 mm, t₁=0.79 mm, t₂=3.4 mm, R_{V1}=R_{V2}=7.75 mm are employed. The impedance matching bandwidths for port 113-1 and port 113-2 are the same as described above with the first embodiment, i.e., the first set of parameters, mentioned above with regard to FIG. 1. However, in this embodiment, the gain G for each port, which are the same because the shape is square, is G=6.64 dBi, which is at 3.5 GHz, and is about 0.3 dB lower than the ones shown in FIGS. 4-6. The slight decrease in gain is due to the fact that the FR4 dielectric in this PCB embodiment has a higher loss that the Rogers RO4003C dielectric. Similarly, the radiation efficiencies for either port are 91%, rather than 97% when using the Rogers RO4003C dielectric.

The design of antenna structure 100 has successfully minimized the dielectric loss effects, leaving mostly the conductor loss as the principal loss mechanism, as can be seen from the fact that the Rogers RO4003C dielectric and the Isola FR408 dielectric have very different loss tangents, the Isola FR408 loss tangent being 4 times that of the Rogers RO4003C dielectric, and still the effect of changing dielectrics on the antenna properties is minimal, as described above. Thus, antenna structure 100 is a significant improvement over standard printed antenna designs, where the loss of the whole dielectric volume used contributes to the reduction of antenna efficiency and corresponding gain.

The same effect is generally seen when using the same design parameters as noted above using FR4 PCB, e.g., one using ISOLA FR408 dielectric, but the size of PCB 111 is changed to 45×55 mm². For such an embodiment, there are two gains, G1, for port 1 and G2 for port 2, which are slightly different because of the rectangular shape of PCB 111, which, unlike a square, is not symmetric. The gains at 3.5 GHz are G=6.44 dBi and G2=6.85 dBi. These gains are about 0.3 dB lower than when using Rogers RO4003C. Similarly, the radiation efficiencies for either port are 90%, rather than 97% when using the Rogers RO4003C dielectric, for the same reason noted above.

Similarly with regards to the embodiments of FIGS. 8, 16, and 22, ISOLA FR408 dielectric may be employed in lieu of Rogers RO4003C dielectric. In each case, to accommodate the change, the value of D₁ should be set to 24.5 mm

Table 1 summarizes the features of embodiments employing arrays of antenna structures 100, e.g., as shown in FIGS. 8, 16, and 22. Table 1 includes the beamwidth for each scanning condition, measured in degrees from the peak of the beam up to the −3 dB beam value in either direction from the peak, for both symmetry planes of the beam, termed “Narrow Beamwidth” and “Broad Beamwidth”, in Table 1. In Table 1, G(0°) denotes the gain at broadside, when all active ports are firing in-phase, θₘₐₓ denotes the maximum scan angle for the scanning conditions described earlier, and G(θₘₐₓ) denotes the gain of the scanned beam at that scan angle. The column of the maximum side-lobes contains their size relative to the corresponding gain of the main beam, hence use of the minus sign. As with the gains of the embodiments of a single one of antenna structures 100, the difference in gain between corresponding arrays and scanning conditions due to the change of the PCB material and the change in size of metal layer M1 101 is only in the range of 0.2 dB for in-phase excitation to 0.6 dB for the maximum scan angle.

TABLE 1

| Cell size & | Array | Narrow | Broad | G(0°)[dBi] | G(θₘₐₓ)[dBi] | Max side- |
|---|---|---|---|---|---|---|
| technology | Design | Beamwidth | Beamwidth | @ 3.5 GHZ | @ θₘₐₓ | lobe @ θₘₐₓ |
| 55 × 45 mm² | 2 × 6 Size: | ±8° | ±19° | 16.71 | 14.29 @ | −10 dB |
| Rogers | 11 × 27 cm² | | | | ±50° | |
| 55 × 45 mm² | 2 × 6 Size: | ±8° | ±19° | 16.43 | 13.77 @ | −10 dB |
| Isola | 11 × 27 cm² | | | | ±50° | |
| 40 × 40 mm² | 4 × 8 Size: | ±7° | ±14° | 19.44 | 16.36 @ | −11 dB |
| Rogers | 16 × 32 cm² | | | | ±58° | |
| 40 × 40 mm² | 4 × 8 Size: | ±7° | ±14° | 19.24 | 15.70 @ | −11 dB |
| Isola | 16 × 32 cm² | | | | ±58° | |
| 55 × 45 mm² | 4 × 8 Size: | ±6° | ±10° | 21.17 | 18.20 @ | −10 dB |
| Rogers | 22 × 36 cm² | | | | ±52° | |
| 55 × 45 mm² | 4 × 8 Size: | ±6° | ±10° | 20.86 | 17.66 @ | −10 dB |
| Isola | 22 × 36 cm² | | | | ±52° | |

The foregoing merely illustrates the principles of the invention. It will thus be appreciated that those skilled in the art will be able to devise various arrangements that, although not explicitly described or shown herein, embody the principles of the invention and are included within its spirit and scope. In particular, those of ordinary skill in the art will be able to select appropriate materials and dimensions to create antennas that operate at different frequencies than the ones disclosed hereinabove. Furthermore, all examples and conditional language recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A monolithic antenna structure, comprising:
a first metal layer;
a second metal layer;
a third metal layer arranged as a ground plane;
a first dielectric layer between the first metal layer and the second metal layer;
a second dielectric layer between the second metal layer and the third metal layer;
a via feeding a signal for transmission by the antenna structure through the second dielectric layer to the second metal layer;
wherein the first metal layer and the second metal layer are not electrically connected; and
wherein the first metal layer acts primarily as the radiating element of the monolithic antenna structure.

2. The monolithic antenna structure of claim 1, further comprising a second via feeding a second signal for transmission by the antenna structure through the second dielectric layer to the second metal layer.

3. The monolithic antenna structure of claim 2, wherein the second signal is the same as the signal but with a different phase.

4. The monolithic antenna structure of claim 1, wherein the first dielectric layer and the second dielectric layer are made of the same material.

5. The monolithic antenna structure of claim 1, wherein the first dielectric layer and the second dielectric layer are both made of a Rogers RO4003C low-loss dielectric.

6. The monolithic antenna structure of claim 1, wherein the first dielectric layer and the second dielectric layer are both made of a standard FR4 PCB containing ISOLA FR408.

7. The monolithic antenna structure of claim 1, wherein the first dielectric layer and the second dielectric layer have different thicknesses.

8. The monolithic antenna structure of claim 1, wherein the wherein the first dielectric layer and the second dielectric layer have different thicknesses, the first dielectric layer being thinner than the second dielectric layer.

9. The monolithic antenna structure of claim 1, further comprising a solder mask over the first metal layer on a surface thereof distal from the first dielectric layer.

10. The monolithic antenna structure of claim 1, further comprising a solder mask over the third metal layer on a surface thereof distal from the second dielectric layer.

11. The monolithic antenna structure of claim 1, wherein the metal of each of the first metal layer, the second metal layer, and the third metal layer is copper.

12. The monolithic antenna structure of claim 1, wherein the first metal layer, the second metal layer, the third metal layer, the first dielectric, and the second dielectric are integrated as part of a printed circuit board.

13. The monolithic antenna structure of claim 1, wherein D₁ is a diameter of the first metal layer, D₂ is the diameter of the second metal layer, t₁ is the vertical distance between adjacent surfaces of the first metal layer and the second metal layer, t₂ is the vertical distance between adjacent surfaces of the second metal layer and the third metal layer, R_{V1} is the distance between the center of the second metal layer and the center of the via, R_{V2} is the distance between the center of the second metal layer and the center of a second via, wherein the monolithic antenna structure has D₁=24.85 mm, D₂=17.61 mm, t₁=0.79 mm, t₂=3.4 mm, R_{V1}=R_{V2}=7.75 mm and wherein the monolithic antenna structure has an area of 40×40 mm².

14. The monolithic antenna structure of claim 1, wherein D₁ is a diameter of the first metal layer, D₂ is the diameter of the second metal layer, t₁ is the vertical distance between adjacent surfaces of the first metal layer and the second metal layer, t₂ is the vertical distance between adjacent surfaces of the second metal layer and the third metal layer, R_{V1} is the distance between the center of the second metal layer and the center of the via, R_{V2} is the distance between the center of the second metal layer and the center of a second via, wherein the monolithic antenna structure has D₁=24.88 mm, D₂=13.21 mm, t₁=0.79 mm, t₂=3.4 mm, R_{V1}=R_{V2}=5.81 mm and wherein the monolithic antenna structure has an area of 40×40 mm².

15. The monolithic antenna structure of claim 1, further comprising a solder mask at least over the first metal layer on a surface thereof distal from the first dielectric layer, wherein D₁ is a diameter of the first metal layer, D₂ is the diameter of the second metal layer, t₁ is the vertical distance between adjacent surfaces of the first metal layer and the second metal layer, t₂ is the vertical distance between adjacent surfaces of the second metal layer and the third metal layer, R_{V1} is the distance between the center of the second metal layer and the center of the via, R_{V2} is the distance between the center of the second metal layer and the center of a second via, wherein the monolithic antenna structure has D₁=24.75 mm, D₂=17.61 mm, t₁=0.79 mm, t₂=3.4 mm, R_{V1}=R_{V2}=7.75 mm and wherein the monolithic antenna structure has an area of 45×55 mm².

16. The monolithic antenna structure of claim 1, wherein D₁ is a diameter of the first metal layer, D₂ is the diameter of the second metal layer, t₁ is the vertical distance between adjacent surfaces of the first metal layer and the second metal layer, t₂ is the vertical distance between adjacent surfaces of the second metal layer and the third metal layer, R_{V1} is the distance between the center of the second metal layer and the center of the via, R_{V2} is the distance between the center of the second metal layer and the center of a second via, wherein the monolithic antenna structure has D₁=24.75 mm, D₂=17.61 mm, t₁=0.79 mm, t₂=3.4 mm, R_{V1}=R_{V2}=7.75 mm and wherein the monolithic antenna structure has an area of 40×40 mm².

17. The monolithic antenna structure of claim 1, wherein the thickness of each of the first metal layer, the second metal layer, and the third metal layer may each independently be in the range from about 15 μm to 70 μm.

18. A dual polarization antenna comprising a plurality of monolithic antenna structures, wherein each monolithic antenna structure comprises:
a first metal layer;
a second metal layer;
a third metal layer arranged as a ground plane;
a first dielectric layer between the first metal layer and the second metal layer;
a second dielectric layer between the second metal layer and the third metal layer;
a via feeding a signal for transmission by the antenna structure through the second dielectric layer to the second metal layer;
wherein the first metal layer and the second metal layer are not electrically connected; and
wherein the first metal layer acts primarily as the radiating element of the monolithic antenna structure;
wherein the plurality of monolithic antenna structures are formed in a single printed circuit board.

19. The dual polarization antenna of claim 18, wherein the via of each of at two of the monolithic antenna structures is supplied with a different signal as its respective signal for transmission.

20. The dual polarization antenna of claim 18, wherein each monolithic antenna structure of the plurality of monolithic antenna structures has an identical structure, and wherein D₁ is a diameter of the first metal layer, D₂ is the diameter of the second metal layer, t₁ is the vertical distance between adjacent surfaces of the first metal layer and the second metal layer, t₂ is the vertical distance between adjacent surfaces of the second metal layer and the third metal layer, R_{V1} is the distance between the center of the second metal layer and the center of the via, R_{V2} is the distance between the center of the second metal layer and the center of a second via, wherein the monolithic antenna structure has D₁=24.85 mm, D₂=17.61 mm, t₁=0.79 mm, t₂=3.4 mm, R_{V1}=R_{V2}=7.75 mm and wherein the monolithic antenna structure has an area of 40×40 mm².

21. The dual polarization antenna of claim 18, wherein each monolithic antenna structure of the plurality of monolithic antenna structures has an identical structure, and wherein D₁ is a diameter of the first metal layer, D₂ is the diameter of the second metal layer, t₁ is the vertical distance between adjacent surfaces of the first metal layer and the second metal layer, t₂ is the vertical distance between adjacent surfaces of the second metal layer and the third metal layer, R_{V1} is the distance between the center of the second metal layer and the center of the via, R_{V2} is the distance between the center of the second metal layer and the center of a second via, wherein the monolithic antenna structure has D₁=24.88 mm, D₂=13.21 mm, t₁=0.79 mm, t₂=3.4 mm, R_{V1}=R_{V2}=5.81 mm and wherein the monolithic antenna structure has an area of 40×40 mm².

22. The dual polarization antenna of claim 18, wherein each monolithic antenna structure of the plurality of monolithic antenna structures has an identical structure, each monolithic antenna structure further comprising a solder mask at least over the first metal layer on a surface thereof distal from the first dielectric layer, wherein D₁ is a diameter of the first metal layer, D₂ is the diameter of the second metal layer, t₁ is the vertical distance between adjacent surfaces of the first metal layer and the second metal layer, t₂ is the vertical distance between adjacent surfaces of the second metal layer and the third metal layer, R_{V1} is the distance between the center of the second metal layer and the center of the via, R_{V2} is the distance between the center of the second metal layer and the center of a second via, wherein the monolithic antenna structure has D₁=24.75 mm, D₂=17.61 mm, t₁=0.79 mm, t₂=3.4 mm, R_{V1}=R_{V2}=7.75 mm and wherein the monolithic antenna structure has an area of 45×55 mm².

23. The dual polarization antenna of claim 18, wherein each monolithic antenna structure of the plurality of monolithic antenna structures has an identical structure, and wherein D₁ is a diameter of the first metal layer, D₂ is the diameter of the second metal layer, t₁ is the vertical distance between adjacent surfaces of the first metal layer and the second metal layer, t₂ is the vertical distance between adjacent surfaces of the second metal layer and the third metal layer, R_{V1} is the distance between the center of the second metal layer and the center of the via, R_{V2} is the distance between the center of the second metal layer and the center of a second via, wherein the monolithic antenna structure has D₁=24.75 mm, D₂=17.61 mm, t₁=0.79 mm, t₂=3.4 mm, R_{V1}=R_{V2}=7.75 mm and wherein the monolithic antenna structure has an area of 40×40 mm².

24. The dual polarization antenna of claim 18, wherein the via of each of at two of the monolithic antenna structures is supplied with a different signal as its respective signal for transmission.

25. The dual polarization antenna of claim 18, wherein the plurality of monolithic antenna structures are arranged as an array.

26. The dual polarization antenna of claim 25, wherein the array is one of 2×6 and 4×8.
